(19) United States
(12) Patent Application Publication
(10) Pub. No.: US 2017/0364917 A1
(43) Pub. Date: Dec. 21, 2017

(54) ASSURANCE OF IDENTITY INFORMATION

(71) Applicant: iSignthis Ltd, Tortola (VG)

(72) Inventor: Nickolas John Karantzis, Richmond, VIC (AU)

(21) Appl. No.: 15/536,219

(22) PCT Filed: Dec. 17, 2015
(86) PCT No.: PCT/AU2015/050804

§ 371 Date: Jun. 15, 2017

(30) Foreign Application Priority Data
Dec. 17, 2014 (AU) 2014905116

(51) Int. Cl. G06Q 20/40; G06Q 50/00; G06F 17/30

(52) U.S. Cl. CPC G06Q 20/4016; G06F 17/30035; G06Q 50/01

(57) ABSTRACT

A computer-implemented method for assuring identity information representing identity of an entity is provided. The method determines (210) that a payment is made to a payment recipient using an account associated with the entity. The identity information of the entity is determined (220). A type of the payment recipient is determined (230). The method determines (240) a level of assurance associated with the identity information based on the type of the payment determining that a payment is made to a payment recipient.

### CROSS-REFERENCE TO RELATED APPLICATIONS

The present application claims priority from the Australian provisional application 2014905116 filed on 17 Dec. 2014 with iSignthis Ltd being the applicant and the contents of which are incorporated herein by reference.

### TECHNICAL FIELD

The present disclosure generally relates to security, and in particular assurance of identity information. The present disclosure includes computer-implemented methods, software, and computer systems for assuring identity information representing identity of an entity.

### BACKGROUND

Identifying an entity, whether a natural person or an incorporated body, may be needed for transactions with government agencies or businesses for example, retailers, financial institutions, insurance companies, and financial product brokers.

For online transactions, identity information of the entity may be provided to a government agency or business in a digital form via the internet. Upon confirmation of the identity information, a transaction between the entity and the government agency or business may be conducted. It is important to assure the identity information of the entity in a secure and efficient way.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present disclosure is not to be taken as an admission that any or all of these matters form part of the prior art base or were common general knowledge in the field relevant to the present disclosure as it existed before the priority date of each claim of this application.

### SUMMARY

There is provided a computer-implemented method for assuring identity information representing identity of an entity, including: determining that a payment is made to a payment recipient using an account associated with the entity; determining identity information related to the entity; determining a type of the payment recipient; and determining a level of assurance associated with the identity information based on the type of the payment recipient.

The level of assurance provides a measure of the degree of certainty of the identity information of a user. It is an advantage that the level of assurance determined improves reliability of the identity information of the user when conducting an online transaction. Importantly, this in turn better secures the online transaction. The computer-implemented method also provides automation in determining the level of assurance associated with identity information that is advantageous over manually assuring identity information.

As described in detail below, the method operates with a communications network, a payment network, and multiple databases to determine the level of assurance. Particularly, the method may be performed by receiving relevant information over a communications network, which allows the method to be performed quickly, and in particular where transactions occur between geographically separated parties. This cannot be achieved by a human.

Further, the method allows timely determination of the level of assurance as a computer can make multiple determinations for multiple entities having transactions with multiple payment recipients faster than determinations done manually. Equally as efficiently the multiple determinations of level of assurance are available instantly to other users of the network.

The method also allows consistency in determining the level of assurance. For example, level of assurance is based on the type of payment recipient, and a particular payment recipient may have the respective “type of payment recipient” classification change over time. Such dynamic changes in classification may be due to a change in status of the payment recipient or based on analysis of historical occurrences of fraud with that payment recipient. The method advantageously allows determining (and re-determining) a level of assurance of multiple entities by applying changes to the type of payment recipient consistently to multiple determinations. Furthermore, since many transactions are performed online with processing of transactions for at least one of the parties (such as the payment recipient) done automatically by a computer, it would be difficult (if not impossible) to manually monitor every transaction performed. Therefore manual determinations of assurance may not be practical, economical, or feasible.

The computer-implemented method may further include storing the level of assurance in a database.

In the computer-implemented method, the step of determining the level of assurance may further include determining the level of assurance based on the identity information.

In the computer-implemented method, the step of determining the identity information may also include determining the identity information based on a further account associated with the entity.

In the computer-implemented method, the type of the payment recipient may include a regulated payment recipient and an unregulated payment recipient. The regulated payment recipient may include one or more of the following: a utility company; a government agency; a financial institution; a quasi-government agency; and an entity regulated under anti-money laundering, counter terrorism funding, bank secrecy or financial regulatory requirements.

In the computer-implemented method, determining the level of assurance may further include: comparing the identity information with a record representing the identity of the entity in a third-party database; and determining the level of assurance based on the comparing. The third-party database may include one or more of a government agency database, a credit agency database and a databroker database.

In the computer-implemented method, the account may include: a bank account, a debit card account, a credit card account, a charge card account, a loyalty card account, a public transport access card account or combination thereof

The computer-implemented method may further include determining a token based on the identity information and the level of assurance. The token may contain one or more of the following: a name of the entity; a unique identifier associated with the entity; the level of assurance; a date of assurance; an address; a date of birth; citizenship; loyalty scheme memberships; tax file number; passport number, with expiry and place of issue; driver license data; and a social security number.

The computer-implemented method may further include storing the token on a storage medium, wherein the storage medium comprises a debit card, a credit card, a charge card, a loyalty card, a public transport access card, a cloud storage network, a mobile computing device, a Subscriber Identity Module (SIM) of a mobile phone, an identity service provider database and a smart card that is incorporated into another medium.

In the computer-implemented method, determining the level of assurance further includes determining the level of assurance based on one or more factors including: type of account; verified possession of a mobile phone by the entity; device information of a device the payment was made with; when a utility has been paid by the entity; type of utilities paid by the entity; failed payment authentications associated with the entity; authenticated transactions made to utilities; regulated payment recipients have been paid; a social network account associated with the entity; an amount of the payment; data routing and domain information of the payment; an email account associated with the entity; and a face-to-face check of proof of identity documents of the entity.

In the computer-implemented method, determining the level of assurance may further include: assigning weights to one or more of the one or more factors; and determining the level of assurance based on weights.

The computer-implemented method may further include the step of updating a previous level of assurance associated with the identity information of the entity with the level of assurance.

The computer-implemented method may further include: receiving a query regarding the level of assurance associated with the identity information; and sending a message indicative of the level of assurance associated with the entity.

There is also provided a computer-implemented method of performing a transaction between a payment recipient and an account associated with an entity, wherein the identity of the entity is represented by identity information, the method including: receiving a request for the transaction between the payment recipient and the account associated with the entity; sending a query regarding the level of assurance associated with the identity information; receiving a message indicative of the level of assurance associated with the entity according to the above described method; determining a transaction is approved or not approved based on the level of assurance and a level of assurance threshold; and conducting the transaction if the transaction is approved.

There is also provided a computer-implemented method of approving a transaction between a payment recipient and an account associated with an entity, wherein the identity of the entity is represented by identity information, the method including: determining a level of assurance associated with the identity information according to the above described method; and determining a transaction is approved or not approved based on the level of assurance. The computer-implemented method may further include: receiving a query regarding the identity information in the transaction; and sending a message indicative of a result of determining the transaction is approved or not approved.

There is also provided a computer-implemented method of performing a transaction between a payment recipient and an account associated with an entity, wherein the identity of the entity is represented by identity information, the method including: receiving a request for the transaction between the payment recipient and the account associated with the entity; sending a query based on the identity information in the transaction; receiving a message indicative of a result of determining the transaction is approved or not approved according to the method described above; and conducting the transaction if the transaction is approved.

There is provided a non-transitory computer readable medium having computer readable instructions for assuring identity information representing identity of an entity, including: determining that a payment is made to a payment recipient using an account associated with the entity; determining the identity information of the entity; determining a type of the payment recipient; and determining a level of assurance associated with the identity information based on the type of the payment recipient.

There is provided a computer program including machine-executable instructions to cause a processing device to implement the method described above.

There is provided a computer system for assuring identity information representing identity of an entity, including: a memory to store instructions; a bus to communicate the instructions from the memory; a processor to perform the instructions from the memory communicated via the bus: to determine that a payment is made to a payment recipient using an account associated with the entity; to determine the identity information of the entity; to determine a type of the payment recipient; and to determine a level of assurance associated with the identity information based on the type of the payment recipient.

There provided a computer system for performing a transaction between a payment recipient and an account associated with an entity, wherein the identity of the entity is represented by identity information, comprising:
a memory to store instructions;
a bus to communicate the instructions from the memory;
a processor to perform the instructions from the memory communicated via the bus to perform the method described above of performing a transaction between a payment recipient and an account associated with an entity.

### BRIEF DESCRIPTION OF THE DRAWINGS

Features of the present disclosure are illustrated by way of non-limiting examples, and like numerals indicate like elements, in which:

FIG. 1 illustrates an example transaction system according to the present disclosure;

FIG. 2a illustrates an example method for assuring identity information representing identity of a user;

FIG. 2b illustrates an example method for assuring identity information representing identity of a user;

FIG. 3 illustrates an example method for storing a level of assurance;

FIG. 4 illustrates an example method for applying a level of assurance;

FIG. 5 illustrates an example method for determining a level of assurance;

FIG. 6 illustrates an example method for determining a level of assurance;

FIG. 7 illustrates an example identity profile database;

FIGS. 8a and 8b illustrate example payment recipient databases; and

FIG. 9 illustrates an example identity agent according to present disclosure.

### DETAILED DESCRIPTION

### Introduction

Proof of identity may be a document issued for an entity to identify the entity. The proof of identity may include a birth certificate, a passport, a marriage certificate, criminal record check, or a driver license for an individual, or a certificate of incorporation, or a registration certificate for a business. The proof of identity may contain identity information that identifies the entity, for example, the entity's address, date of birth, electoral roll registration, criminal record, credit rating, prior loan details, passport number and expiry, driver license number and expiry, marriage certificate, and social security number, or in the case of a business, its registered address, names of directors and date of incorporation.

Payment or financial accounts, including bank accounts, credit cards, debit cards, eWallets, mWallets, and eMoney accounts, may also be associated with a person's identity. In many cases these payment or financial accounts are only issued to the entity upon the issuing bank or financial institution being satisfied as to the entity's identity. Transactions on these payment accounts, including those made online as ‘card not present’ credit or debit card transactions, direct debits, online banking electronic payment (OBeP), or via eWallets, mWallets or person to person eMoney transfers, are often authenticated to ensure that the owner of the account has approved the transaction. Card schemes, such as MAESTRO, VPAY, CARTA SI, DANKORT, PLUS, CIRRUS CARD, VISA, MASTERCARD, EFTPOS, CHINA UNIONPAY, AMERICAN EXPRESS, DINERS CLUB, DISCOVER, CARTE BLEUE, JCB CARD and KOREAN BC CARD may authenticate transactions originating on credit or debit cards. Issuing banks such as HSBC, ANZ, Westpac, Citibank, Lloyds, Barclays, ABN AMRO, or BNP Paribas may also authenticate transactions originating on credit or debit cards. Issuing banks or third party service providers may authenticate transactions processed via direct debit, OBeP or eMandates.

In addition, eWallet operators such as Google, Amazon, PayPal or Apple Pay may also incorporate transaction authentication means.

The increasing use of computer technologies makes it possible to record identity information that is not suitable for paper medium, for example, biometrics and DNA identity information, in conjunction with other proof of identity data. As a result, the identity information may be recorded in a database operated by a government or a business. The identity information may also be stored on a personal storage medium of the entity including mobile devices.

Proof of identity can be used to confirm the identity of the entity so as to have certain transactions conducted that satisfy particular security or regulatory requirements.

Identity of an entity may be proven, whether in-person or online, by checking identity information provided by the entity against details that are accessible from a database operated by a bank, a government agency, a databroker, or a credit agency to confirm that they are the same.

For an online transaction, it is desirous to provide a party to the transaction with a degree of certainty that the identity information accurately represents the entity that is involved in the transaction and provides the identity information. To do this, a level of assurance associated with the identity information is used in the present disclosure.

The level of assurance may be measured and expressed in different forms. In one example, the level of assurance may be represented by a numerical score. In other examples the level of assurance may be expressed as distinct categories, such as a high level of assurance, intermediate level of assurance and a low level of assurance.

In some examples, the level of assurance is expressed as a numerical score where a higher level of assurance score represents a higher degree of certainty that the identity information represents the entity. That is, if the entity is identified by identity information that has a higher level of assurance score, the risk resulting from identity fraud caused by the entity may be lower.

In other examples, the numerical level of assurance score may be expressed such that a lower level of assurance score may represent a higher degree of certainty. In yet another embodiment, a numerical level of assurance score may be expressed such that interpretation of the level of assurance is based on the deviation of the numerical level of assurance score from a reference score.

The level of assurance discussed in the examples below refer to a reference where the higher of level of assurance score is indicative of a higher degree of certainty that the identity information represents the entity providing the information. However, it is to be appreciated that other measures and expressions of the level of assurance may be used without departing from the scope of the present disclosure. Together, all these scores, measures and expressions are referred to collectively as “level of assurance”.

### Description of an Example Transaction System

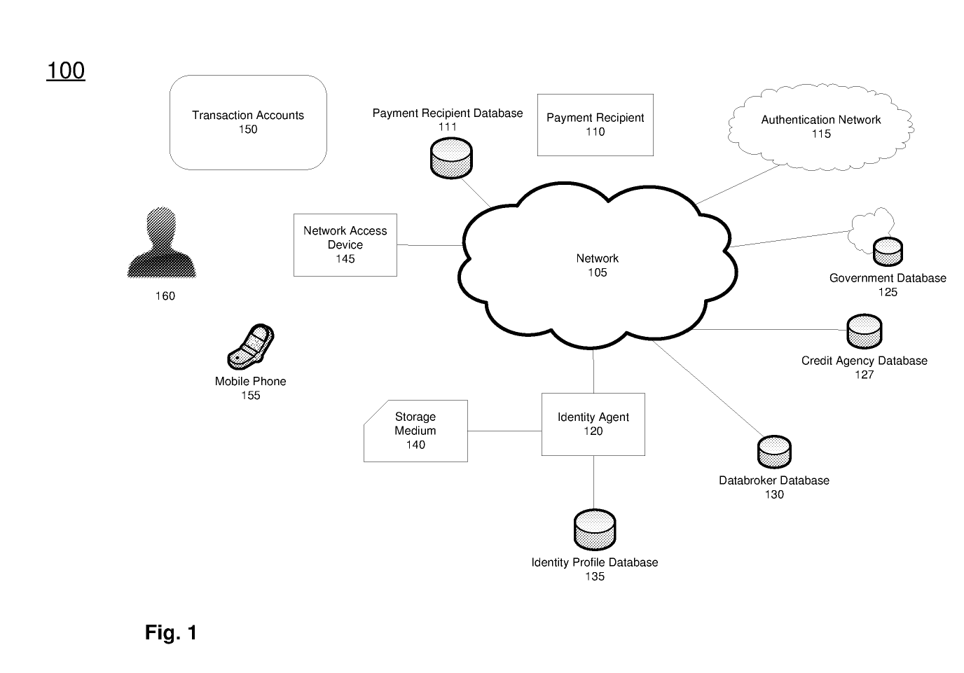

FIG. 1 illustrates an example transaction system 100 according to the present disclosure. The system 100 includes a network 105, a payment recipient 110, a payment recipient database 111, an authentication network 115, an identity agent 120, third-party databases being a government database 125, a credit agency database 127 or a databroker database 130, an identity profile database 135, a storage medium 140, and a network access device 145.

The network 105 is a network that communicates information between the network elements in the system 100, which may be for example a local area network (LAN), a wireless local area network (WLAN), a wide area network (WAN), a cellular telecommunication network, the internet, or a combination thereof.

The payment recipient 110 may include an organisation that receives a payment from an entity 160, referred to as a user 160 hereinafter, for a transaction conducted by the user 160 with a party. In this example, for easy description, the payment recipient 110 and the party that the user 160 conducts the transaction with are the same organisation. In other examples, the payment recipient 110 and the party that the user 160 conducts the transaction with may be different organisations without departing from the scope of the present disclosure.

The network access device 145 is a device that provides the user 160 with an access to the network 105, which may be is a desktop, a laptop or a mobile phone that user 160 can use to access the network 105 to make a payment to the payment recipient 110 through the network 105.

The identity agent 120 analyses transactions based on the identity information provided by the user 160 and determines the level of assurance associated the identity information, which is described below in detail.

The identity profile database 135 stores the identity information of the user 160 and the level of assurance associated with the identity information.

The authentication network 115 is a network that provides authorisation and authentication services for a transaction, for example, a payment made by the user 160 using an account 150 associated with the user 160, to the payment recipient 110. The authentication network 115 may be a financial network that can allow or reject a payment request from the user 160 by checking the identity information provided by the user 160 against identity information on record and determining that sufficient funds are available.

The third-party databases, which may include the government database 125, the credit agency database 127 and the databroker database 130, may record the identity information of the user 160.

It should be noted that although the network elements in FIG. 1 are shown as separate network elements, one network element may be part of another network element either logically or physically. For example, the identity profile database 135 may be part of the identity agent 120 or the authentication network 115, and the identity agent 120 may be part of the authentication network 115.

Further, the link between these network elements may take a variety of forms where appropriate. For example, the link may be a wireline communication link, a wireless communication link, an optical communication link, an access network, or a combination thereof.

### Description of an Example Method for Assuring Identity Information of the User

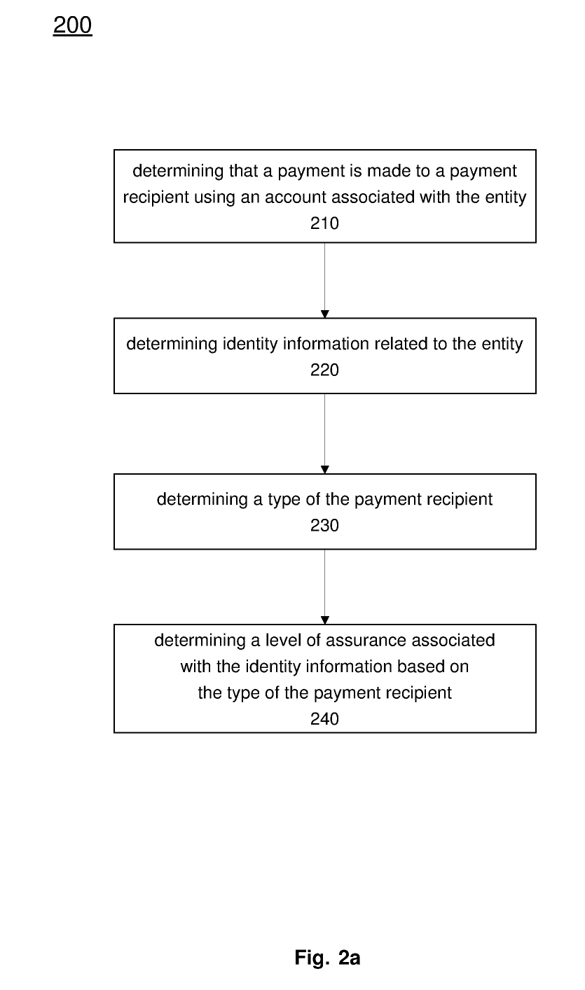

FIG. 2a illustrates an example method 200 for assuring identity information representing identity of a user 160 performed by the identity agent 120.

In the example illustrated in FIG. 2a, the method includes determining 210 that a payment is made to the payment recipient 110 from the user 160 using the account 150 associated with the user 160. The method also includes determining 220 the identity information of that user 160, and determining 230 a type of the payment recipient 110.

The method also includes determining 240 a level of assurance that is associated with the identity information of the user 160, based on the type of payment recipient 160.

The level of assurance provides a measure of the degree of certainty of the identity information of the user 160. It is an advantage that the level of assurance determined improves reliability of the identity information of the user 160 when conducting an online transaction. The computer-implemented method also provides automation in determining the level of assurance associated with identity information that is advantageous over manually assuring identity information. For example, determination of the identity information can increase reliability by removing subjectivity and/or prejudices that a person manually making the assurance may have regarding the entity, the payment recipient, the type of payment recipient, and/or the identity information. The present computer-implemented method solves this issue by providing a technical solution with a computer that creates data relating to the type of payment recipient and identifies a technical means of generating this new data for use in the method. The technical solution also uses that new data in a new way to create a level of assurance that is objective as well as measurable and comparable. Using the level of assurance, the reliability of the identity information of the user 160 is identifiable, and the online transaction in which the user 160 is involved can be better secured.

The computer-implemented method also allows timely determination of a level of assurance as a computer can make multiple determinations for multiple entities having transactions with multiple payment recipients faster than determinations done manually. Furthermore the computer-implemented method may be performed by receiving relevant information over a communications network, which allows the method to be performed quickly, and in particular where transactions occur between geographically separated parties. Equally as efficiently the multiple determinations of level of assurance are available instantly to other users of the network.

In another example, the computer-implemented method allows consistency in determining the level of assurance. For example, level of assurance is based on the type of payment recipient, and a particular payment recipient may have the respective “type of payment recipient” classification change over time. Such dynamic changes in classification may be due to a change in status of the payment recipient or based on analysis of historical occurrences of fraud with that payment recipient. The method advantageously allows determining (and re-determining) a level of assurance of multiple entities by applying changes to the type of payment recipient consistently to multiple determinations. Furthermore, since many transactions are performed online with processing of transactions for at least one of the parties (such as the payment recipient) done automatically by a computer, it would be difficult (if not impossible) to manually monitor every transaction performed. Therefore manual determinations of assurance may not be practical, economical, or feasible.

The present method advantageously includes determining the level of assurance of the user 160 by taking into consideration the type of payment recipient 110 that the user 160 has interactions with. The advantages are illustrated by the examples below.

For example, the types of the payment recipient 110 may include a regulated payment recipient and an unregulated payment recipient. In one example, the level of assurance learnt from payments to regulated payment recipients is higher than the level of assurance learnt from payments to unregulated payment recipients. In one example, this differentiation of the level of assurance learnt from regulated payment recipients 110 may reflect the need for higher levels of authentication required for transactions with a regulated payment recipient 110.

The regulated payment recipient may include a government agency, a financial institution, a quasi-government agency, and an organisation regulated under anti-money laundering, counter terrorism funding, bank secrecy or legislative requirements. Such organisations may have relatively higher requirements for authentication and/or validation. For example, a transaction with a regulated payment recipient using the account 150 may require the identity of the user 160 to be authenticated by issuer of the account 150 to confirm that the user 160 is authorized to use the account 150. In addition, or alternatively, a transaction with a regulated payment recipient may require the user 160 to provide additional information to the regulated payment recipient 110, such as a tax file number, social security number, passport number, password, biometric check etc. In yet another example, a regulated payment recipient may require validation of the user 160 in person when initially registering for a service or payment with the regulated payment recipient.

In contrast, an unregulated payment recipient may not have such stringent requirements. The unregulated payment recipient may include a retailer, a merchant, and a utility company. The utility company may include an electric power company, a water supply company, a gas supply company, a telecommunication service provider, a TV service provider, or other service providers that deliver their services to a fixed address. Although the utility company is described as the unregulated payment recipient, since the services of the utility company are delivered to the fixed address, the address may have been confirmed by the utility company, which may provide a certain degree of certainty on data related to the identity of the user 160.

A successful payment to the regulated payment recipient may be indicative of a higher degree of certainty of the identity of the user 160. Thus the level of assurance of the user 160 may be adjusted to incorporate a higher level of assurance score to indicate the new higher degree of certainty on the identity of the user 160. On the other hand, the level of assurance of the user 160 may be adjusted to incorporate a relatively lower level of assurance score if the payment is successfully made to an unregulated payment recipient.

The method 200 may be initiated by actions of the user 160. This may include, for example, the user 160 making a payment to the payment recipient 110 which in turn causes a payment message to be sent to the identity agent 120 (as discussed in detail below with reference to FIG. 2b). In another example, initiation of the method 200 may include the user 160 making a request to the identity agent 120 to perform the method 200 in light of one or more recent payments. In yet another example, the method 200 may be initiated by the identity agent 120 as part of assessment of the level of assurance of the user 160. This assessment may be done on an ad hoc basis, scheduled, and/or routine tasks. In yet another example, the method 200 may be performed at the request of another party.

### Description of a Further Example Method for Assuring Identity Information of the User

A further example of a method 201 for assuring identity information of a user will now be described in detail with reference to FIGS. 2b to 8.

The example method 201 of FIG. 2b is based on the method 200 of FIG. 2a described above, but with additional steps. This method 201 includes the step of initially registering 205 the user 106 with the identity agent 120. The method 201 also includes updating 250 a previous level of assurance with the level of assurance determined at 240, storing 260 the determined level of assurance and applying 270 the determined level of assurance in a transaction.

Registering the User with the Identity Agent (205)

In this example, identity information of the users 160 is stored in the identity profile database 135. The identity information of the user 160 is stored in an identity profile file 136 being an entry in the identity profile database 135.

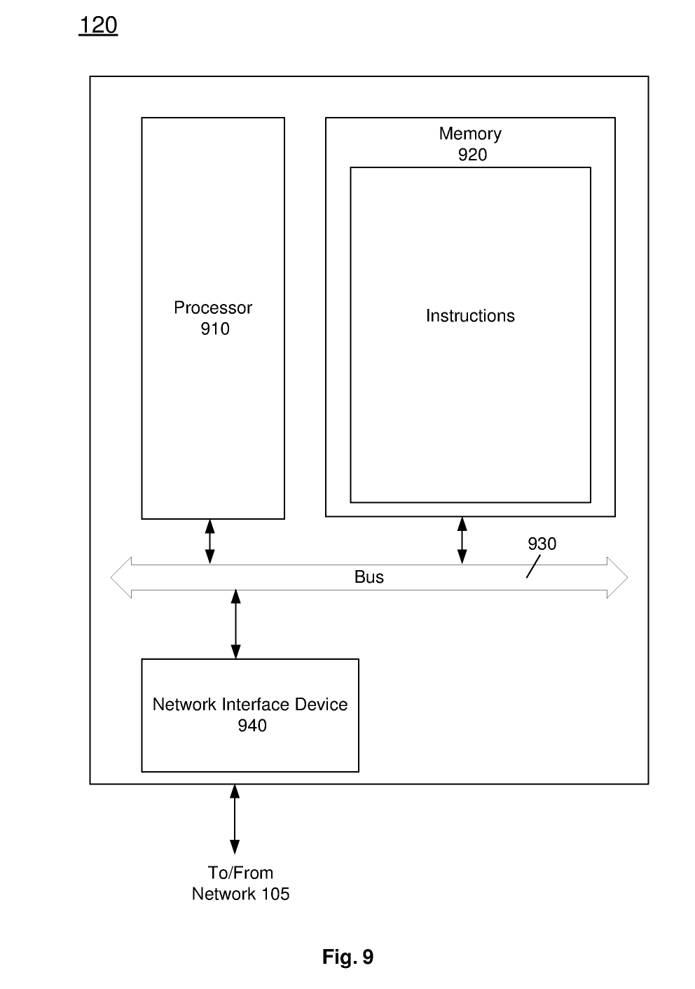

An example identity profile 136 of the identity profile database 135 is shown in FIG. 7. The identity profile file 136 may include the following fields 137, 138, 139: “Identity Information”, “Transaction Account”, and “Level of Assurance”. The “Identity Information” field 137 of the identity profile file 136 contains identity information of the user 160 to identify the user 160 which in this example is a name “John Smith”. The “Transaction Account” field 138 contains the account(s) 150 associated with the identity profile file 136 of the user 160 and in this example includes an account number “Account number 12345”. The “Level of Assurance” field 139 contains the level of assurance score of the user 160, which in this example is “108”.

In this example, the user 160 may send a profile creation message to the identity agent 120 to create the identity profile file 136 of the user 160 in the identity profile database 135. The profile creation message may include the identity information of the user 160.

Upon receipt of the profile creation message, the identity agent 120 may create the identity profile file 136 for the user 160. As a result, the identity information of the user 160 included in the profile creation message is stored in the “Identity Information” field 137 of the identify profile file 136 of the user 160.

Further, the user 160 may send an account association message including account information of the account 150 of the user 160 to the identity agent 120 to associate the account 150 with the identity profile file 136 of the user 160 in the identity profile database 135.

Upon receipt of the account association message, the identity agent 120 may have the account 150 authenticated.

In this example, the identity agent 120 may send the account information of the account 150 included in the account association message and the identity information stored in the “Identity Information” field 137 of the identity profile file 136 of the user 160 to the authentication network 115 to have the account 150 authenticated by the authentication network 115 using an identity authentication means including, Verified by Visa, SecureCode, Safekey, J-Secure, 3D-SECURE, PayPal and ISIGNTHIS. Authentication means may include, in some examples, such means described in US Patent Publications: US 2002/0004772 (Templeton et al.); US 2002/0111919 (Weller et al.); US 2002/0194138 (Dominguez et al.); US 2003/0212642 (Weller et al.); and US 2012/0011066 (Telle et al.). In other examples, the authentication means may include means described in International Patent Publications: WO 2008/131021 (Visa U.S.A. Inc.); WO 2008/144487 (Visa International Service Association); and WO 2010/075077 (Mastercard International Incorporated).

In another example, the identity agent 120 may send the account information of the account 150 and the identity information of the user 160 to a proprietary system that is operated by the issuer that issued the account 150 to the user 160. The account 150 is authenticated by the proprietary system. Such a proprietary system may include two factor or multifactor authentication and/or strong customer authentication.

If the account 150 is successfully authenticated, the identity agent 120 may associate the account 150 with the identity profile file 136 of the user 160 by storing the account information of the account 150 in the “Transaction Account” field 138 of the identity profile file 136 of the user 160.

When the identity profile file 136 is created for the user 160, an initial level of assurance score may be assigned to the identity profile file 136. In this example, the initial level of assurance score of the user 160 is “108”, as shown in the “Level of Assurance” filed 139 of the identity profile file 136 of the user 160.

The user 160 may have a plurality of accounts 150 that are issued by a same issuer or different issuers, the identity profile file 136 may also be associated with the plurality of accounts 150 by the identity agent 120. This way the identity profile file 136 may take advantage of independent authentication methods that may be used by different issuers, providing more secure association of the identity profile file 136 with the accounts 150. Further, cancellation, expiry or revocation of any one account 150 does not necessarily deactivate the identity profile file 136 of the user 160 if more than one account 150 has been associated with the identity profile file 136. The user 160 may control the number of the accounts 150 associated with the identity profile file 136.

Revocation of one of the accounts 150 due to loss, theft, fraud or misuse may be logged and stored in the identity profile file 136, and may lead to suspension of the identity profile 136 until further transactions are authenticated on another associated account 150.

It will be appreciated that the registration process 205 of the user 160 with the identity agent 120 as described above may occur once only and may not be necessary during subsequent performances of the method 201. In other examples, the registration process 205 or part of the registration process 205 may be repeated. For example, the user 106 may only wish to associate a different account 150 with the identity profile file 136 without creating a new identity profile file. In yet another example, the identity information of the user 160 contained in the identity profile file 136 may be updated to ensure the identity information of the user 160 is up-to-date.

### Determining a Payment is Made to a Payment Recipient (210)

The situation where the initiation of the method 200 described with reference to FIG. 2a is caused by a payment by the user 106 to the payment recipient 110 will now be discussed in detail.

In this example, a payment needs to be made to the payment recipient 110 for a purchase of goods or services by the user 160. The user 160 may use the network access device 145 to access the network 105 whereby the user 160 may log in the account 150 and make the payment to the payment recipient 110.

The user 160 may provide, through the network access device 145, authentication information for the account 150 to have the payment authenticated by the authentication network 115. The authentication information may include account information of the account 150, for example, an account number of the account 150, and an expiry date of the account 150. The authentication information may also include identity information of the user 160 that represents identity of the user 160, for example, a name of the user 160, an address of the user 160, a date of birth of the user 160, and a password set by the user 160 to access account 150.

In another example, the user 160 may provide the authentication information for the account 150 by presenting the physical card, for example a credit card or a debit card that is linked to the account 150, to a Point of Sale (POS) provided by the payment recipient 110. The authentication information may be read from the physical card by the POS and sent to the authentication network 115 for authentication. Alternatively, payment account, credit or debit card data may be stored on a mobile device, using mobile payment technology offered by Apple Inc. under the trade mark Apple Pay, or Host-based Card Emulation (HCE) incorporated in the Android operating system offered by Google Inc., either of which may be read at the POS.

Upon receipt of the authentication information for the account 150, the authentication network 115 may send a payment message to the identity agent 120.

The identity agent 120, upon receipt of the payment message, determines 210 that the payment is made to the payment recipient 110 by the user 160 using the account 150.

The payment message may include the authentication information for the account 150.

The payment message may also include information related to the payment recipient 110 for example, a payment recipient ID representing the payment recipient 110. The payment recipient ID may be a text string or a combination of text strings that has literal meaning representing the payment recipient 110, for example, “Macy's at Water Tower, IL”, “7-Eleven Store at 2200 MARKET ST Philadelphia, Pa. 19103”. The payment recipient ID may simply be an alphanumeric string, for example, MCYIL001.

The payment message may further include information related to the type of the payment recipient 110. For example, a “7-Eleven” store may be indicated in the payment message as an unregulated payment recipient, while a “Chase Bank” branch may be indicated as a regulated payment recipient.

It should be noted that the payment message may also be sent from the network access device 145, the payment recipient 110 or other suitable network elements in the system 100 without departing from the scope of the present disclosure.

It is to be appreciated that in other examples, the payment message may not be sent directly to the identity agent 120. For example, records of payment may be stored in a data store, and the identity agent 120 may retrieve the records from the data store periodically or when the identity agent 120 determines that the payment is made to the payment recipient 110.

### Determining the Identity Information of the User (220)

Upon receipt of the payment message at the identity agent 120, the identity agent 120 may determine 220 the identity information of the user 160 from the payment message. As described above, the payment message may include the authentication information of the account 150, which in turn may include the identity information of the user 160 that represents identity of the user 160, for example, a name of the user 160, an address of the user 160, a date of birth of the user 160, a password set by the user 160 to access account 150. As a result, the identity agent 120 may simply read the identity information of the user 160 from the payment message.

This allows the identity agent 120 to select the identity profile file 136 that the payment message relates to.

In other examples, if the identity information of the user 160 is not included in the payment message, the identity information of the user 160 may be sent from the authentication network 115 to the identity agent 120 separately.

### Determining a Type of the Payment Recipient (230)

The method 200 also includes the step of determining 230 a type of the payment recipient. As described above, the payment message may include the type of the payment recipient 110. Therefore, the identity agent 120 may determine 230 the type of the payment recipient 110 from the payment message.

In other examples, if the payment message does not include the type of the payment recipient 110, the identity agent 120 may determine 230 the type of the payment recipient 110 by searching the payment recipient database 111.

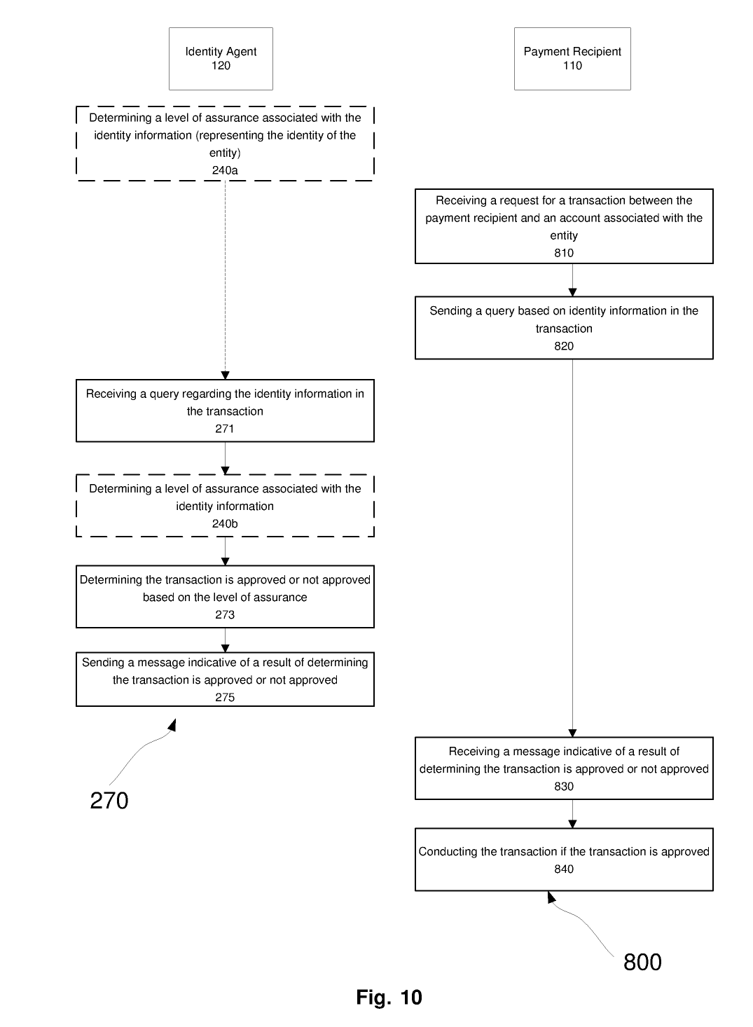

An example payment recipient database 111 is shown in FIG. 8a. In this example, the payment recipient database 111 includes a “Payment Recipient ID” field 710 containing the payment recipient ID that represents the payment recipient 110, and a “Payment Recipient Type” field 720 containing the type of the payment recipient 110. As described above, the identity agent 120 may obtain the payment recipient ID from the payment message. Based on the payment recipient ID, the identity agent 120 determines the type of the payment recipient 110 associated with the payment recipient ID. For example, if the payment recipient ID of the payment recipient 110 is “Macy's at Water Tower, IL”, the payment recipient type of the payment recipient 110 represented by “Macy's at Water Tower, IL” indicates that the payment recipient 110 is an unregulated payment recipient. On the other hand, if the payment recipient ID is “PennDOT Driver License Center”, which is a government agency that governs driver licenses in the State of Pennsylvania, US, the payment recipient type of the payment recipient 110 indicates that “PennDOT Driver License Center” is a regulated payment recipient.

Although this example identifies two types of payment recipients, being regulated and unregulated payment recipients 110, it is to be appreciated that more than two types of payment recipients could be determined in other examples.

In some cases, as illustrated in the payment recipient database 1111 in FIG. 8b, the merchants are grouped 1121, 1123 within merchant category code groups (MCCG) 1121 or are allocated merchant category codes (MCC) 1125, 1127, by the card schemes or acquiring banks. For example, a MCCG for retail stores may be “0521”, with specific MCC codes being “5310” for Discount stores, “5311” for Department stores, “5331” for Variety stores, “5399” for Miscellaneous General Merchandise, or an MCCG of “0811” for Government administration or an MCC of “9311” Tax payments.

Determining a Level of Assurance Associated with the Identity Information Based on the Type of Payment Recipient (240)

The method includes the step of determining 240 a level of assurance based on the type of payment recipient 110 that was determined by the preceding steps. In some examples, as described above, some types of payment recipients 110 (such as regulated payment recipients) may have a higher associated level of assurance than other payment recipients 110 (such as unregulated payment recipients). MCCG or MCC may be linked to predetermined level of assurance scores to be allocated against transactions made with those merchants.

It is to be appreciated that, the type of payment recipient is not an exclusive factor in determining the level of assurance. In the method 201, the identity agent 120 may determine 240 the level of assurance associated with the identity information of the user 160 that is further based on a variety of relevant factors.

Various non-limiting examples of determining 240 the level of assurance will now be described. It is to be appreciated that other methods of determining 240 the level of assurance associated with the identity information based on, at least in part, the type of payment recipient is contemplated by this disclosure. It is to be appreciated that determining 240 the level of assurance may include a combination of one or more of the additional steps described below.

(i) Determining a Level of Assurance with Weighted Factors (500)

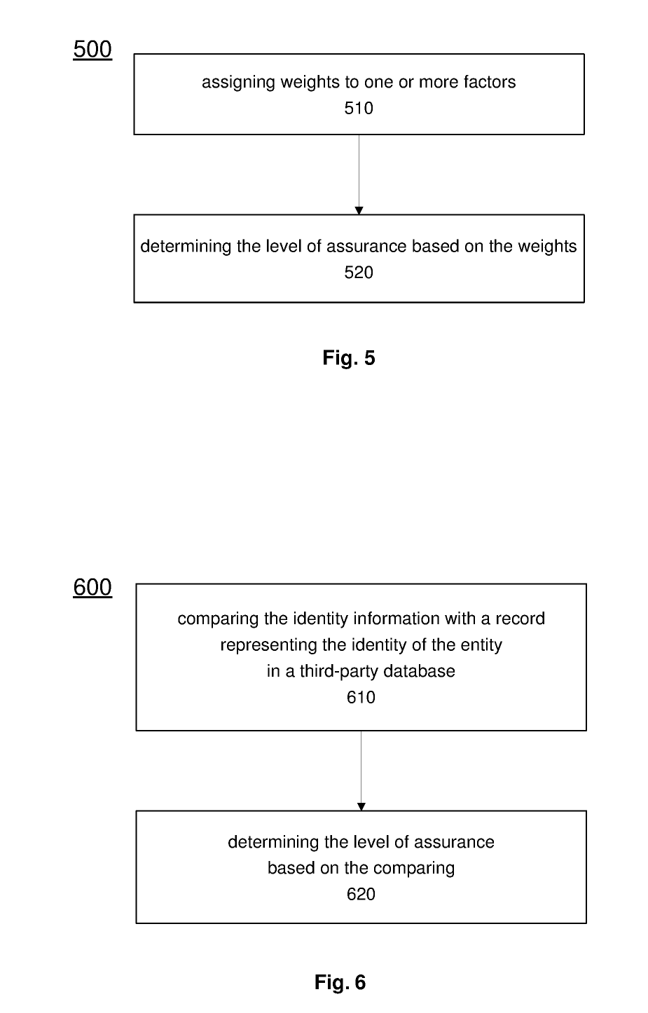

FIG. 5 illustrates an example method 500 for determining a level of assurance based on weighting of relevant factors. The weighting factors may include a weighting based on the type of the payment recipient 110. In this example, the identity agent 120 assigns 510 weights to these factors, and determines 520 the level of assurance based on the weights.

The level of assurance score may be affected by one or more of the following example factors;
the type of the payment recipient 110 (such as regulated or unregulated),
type of account,
verified possession of a mobile phone number by the user,
device information of a device the payment was made with,
when a utility has been paid by the user,
authenticated transactions made to utilities,
payment history for each utility
the number of independent utilities paid,
how recently a utility has been paid,
the type of utilities paid by the user,
authenticated transactions made to regulated payment recipients,
regulated payment recipients paid,
how recently a regulated payment recipient has been paid,
volume of authenticated transactions on the account 150,
number of the accounts 150 linked to the identity profile 136,
failed payment authentications associated with the user,
an amount of the payment,
data routing and domain information of the payment,
email account(s) associated with the entity,
a face-to-face check of proof of identity documents of the entity,
number of the accounts 150 where access by other user(s) has been granted,
the inclusion of the mobile phone 155 with possession verified by use of one time codes sent to the mobile phone 155,
the linking of the identity profile 136 of the user 160 to an identity profile file of an incorporated person,
network data,
data of the network access device 145,
social accounts associated with the user 160, and
proof of identity data of the user 160 and comparison against third-party databases 125, 127, 130.

The above factors may have weights assigned 510 thereto. An example method 500 of determining 520 a level of assurance score based on the weights is given in the equation (1) below.

LoAₜ=RL*t_{decay}*(LoAₜ₋₁+fi+Mv+Mu+Mr+Σ(Scᵢ . . . Scₙ)+Σ(NDᵢ . . . NDₙ)+Σ(DDᵢ . . . DDₙ)+Σ(GDbᵢ . . . GDbₙ)+Σ(DBDbᵢ . . . DBDbₙ)+AuthM−Authf−fiexp) (1)

where
LoAₜ=Level of Assurance score at time “t”;
Mr=payment recipient weight if the payment recipient 110 is a regulated payment recipient. This weight may be calculated based on the number of occurrences that the regulated payment recipient has been paid. The more times the regulated payment recipient has been paid, the higher this weight. For example, Mr=10×the number of occurrences;
Mu=payment recipient weight if the payment recipient 110 is an unregulated payment recipient. The weight Mu may be calculated based on the number of occurrences that the unregulated payment recipient has been paid. The more times the unregulated payment recipient has been paid, the higher the weight Mu. For example, Mu=5×the number of occurrences. However, it can be seen that, with the same number of occurrences that a payment recipient has been paid, the payment recipient weight for the regulated payment recipient Mr is higher than that for the unregulated payment recipient Mu. This reflects the greater level of certainty of the identity information after successful transactions with regulated payment recipients when compared with unregulated payment recipients.
RL=0 if the user's name is on a watch-list, otherwise 1;
t_{decay}=time related variable between any previous authentication. For example, t_{decay} may be equal to 1 if the previous authentication is recent, equal to 0.5 for 6 months, or equal to 0 if the previous authentication is older than 12 months. The time period in which the LoA score decays could be much longer or shorter;
LoAₜ₋₁ is the level of assurance score from the previous calculation;
fi=account weight, calculated according to the type of the account, the issuer, country of issue;
Mv=mobile phone verification confirmed. Weight may deprecate with time and be reset to full weight upon re-verification;
Σ(Scᵢ . . . Scₙ)=Sum of the weights attributed to various verified social accounts, where email may be allocated a certain weight with free emails less weighted than Internet Service Providers (ISPs), government, education organisation or company issued emails, and social media, instant message and other communications means assigned different weights;
Σ(NDᵢ . . . NDₙ)=Sum of the weights attributed to a) collecting network data and b) comparing the data with previously collected data. There may be a plurality of network data that is collected and compared with separate weights per factor;
Σ(DDᵢ . . . DDₙ)=Sum of the weights attributed to a) collecting device data and b) comparing the data with previously collected data where data is consistent. There may be a plurality of network data that is collected and compared with separate weights per factor;
Σ(GDbᵢ . . . GDbₙ)=Sum of the weights attributed to comparison of identity information and records collected with Government databases;
Σ(DBDbᵢ . . . DBDbₙ)=Sum of the weights attributed to comparison of identity information and records collected from other third-party databases;
AuthM=weight attributed to the authentication means used to authenticate the transaction;
Authf=weight attributed to failed authentication attempts using a particular financial or payment instrument; and
fiexp=weight attributed to any particular financial or payment instrument expiring.

Weights may be real numbers, integers or zero for any factor. Additional factors may be added to the above equation (1).

As can be seen from the above example of determining the level of assurance, the level of assurance may further be determined based on the identity information of the user 160. If the identity information of the user 160 indicates that the user 160 is on a watch-list issued by trans-national agencies or the United Nations, the level of assurance score associated with the identity information may be decreased to zero since RL=0 in this case. And the identity profile file 136 may be suspended with a suitable notification issued to the payment recipient 110.

Examples of the watch-list may include entities nominated on the UN Sanctions lists, US Treasury Specially Designated Persons Lists, HM Treasury Financial Sanction Targets lists, the European Union Common Foreign and Security Policy lists and the Australian DFAT consolidated lists. Further examples of the watch-list may include the Europol or Interpol wanted lists or stolen passport lists, or national law enforcement agency lists, including lists such as the FBI's or Homeland Security's wanted lists or local law enforcement agency lists, such as a state police wanted or arrest warrant list.

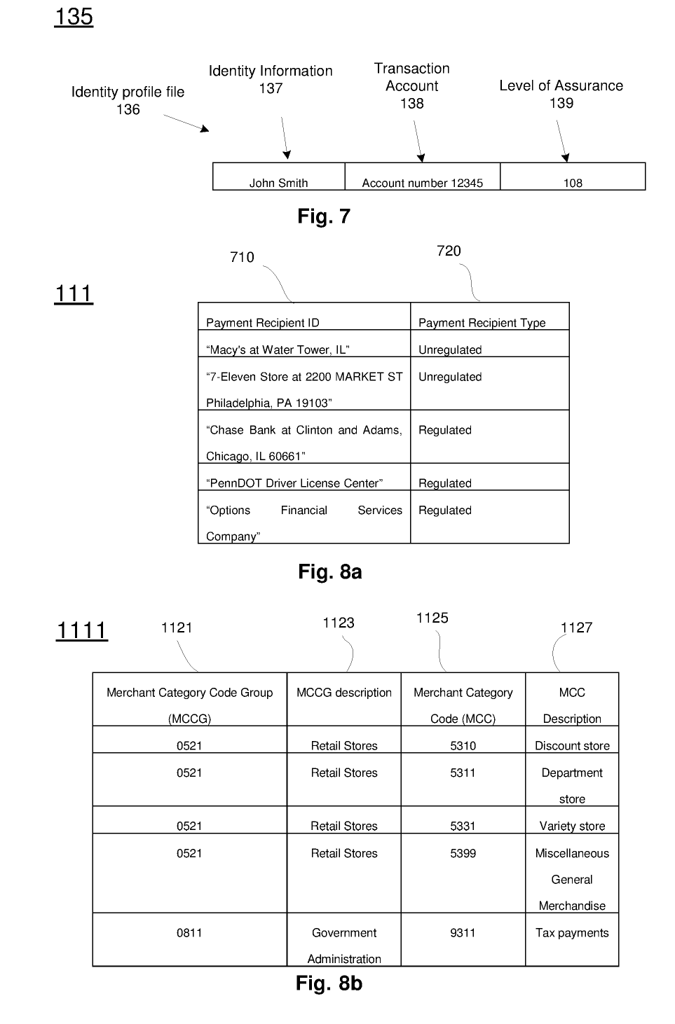

As can be further seen from the above example of determining the level of assurance, the level of assurance may further be determined based on comparison of identity information of the user 160 and records collected from third-party databases, which is described in detail with reference to a method 600 illustrated in FIG. 6.

(ii) Results of a Comparison with Third Party Database as a Further Factor (600)

Another further factor in determining the level of assurance is shown in FIG. 6 and described below. In addition to considering the type of payment recipient 110, the identity agent 120 may compare 610 the identity information of the user 160 with a record representing the identity of the user 160 in the third-party databases 125, 127 or 130. For example, the identity agent 120 may check the electoral roll, social security record, land titles office, immigration record, driver license record, birth record, death record and marriage status record in these third-party databases 125, 127, 130.

The identity agent 120 may determine 620 the level of assurance based on the outcome of the comparison. For example, if the identity information provided by the user 160 matches the record in these third-party databases 125, 127, 130, the level of assurance may be increased. Alternatively, if the identity information provided by the user 160 does not match the record in the third-party databases, the determined level of assurance score may be decreased compared to a previous level of assurance score or increased less than when the identity information provided by the user 160 matches the record in the third-party databases 125, 127, 130.

(iii) Other Factors in Determining Level of Assurance

The following are examples of other factors and methods that may be further used for determining a level of assurance associated with the identity information of a user.

Ongoing authentication of individual payment transactions ensures that the identity profile 136 is current, with the level of assurance being updated over time. For example, as a consequence of no transactions being authenticated within a predetermined period, the level of assurance score may be decreased. Further, the identity profile 136 may be suspended if there are no authenticated transactions within a predetermined time period.

Data consistency may also be taken into account in determining the level of assurance. Data consistency includes there being no network aberrations, for example if the network access device 145 of the user 160 being located within a short period of time in the UK, then in Central Asia, then back to the UK in quick succession, or, operating system language change, or unique device data changing frequently. However a device located in the UK, then France and back to the UK via other EU countries, may not be seen as inconsistent over a short period of time.

Data consistency utilising risk based approaches may include geo-location whitelists and blacklists, transaction velocity, transaction velocity compared to geo-location of the payment recipient 110, and may include weighting factors such as device language being consistent with geo-location of the user 160, IMEI remaining constant, the mobile phone number remaining reasonably constant.

The level of assurance score in the identity profile file 136 of the user 160 may also be increased if identity documents are validated in person. For example, a passport or driver license may be taken into a location including a local post office, financial institution or any other trusted service provider for an identity validation. As a result, the identity profile file 136 can be augmented with details appended regarding when the identity check was validated, by whom and where, with information that the passport or driver license has been validated. A photograph or biometric information may be taken and uploaded to the identity profile file 136 in the identity profile database 135. A government agency may also perform a similar validation and append the information to the identity profile file 136 of the user 160.

The level of assurance score in the identity profile file 136 may be decreased if the user 160 is inactive over a time period, or, if any one of the accounts 150 associated with the identity profile file 136 expire (eg credit or debit card).

The level of assurance score need not be a predetermined scale. Users may have multiple accounts and different social footprints with various numbers of utilities and regulated entities, such that the level of assurance score for one user may be different to that of another.

Further factors that may affect the level of assurance may include the number of the accounts associated with the identity profile file 136, the type, account schemes and county of issue of the accounts 150, the number of utilities to whom payment has been made and authenticated, the issuers of the accounts 150, payments that have been made to different payment recipients 110. For example, each time a utility company is paid, the level of assurance may be increased as there is an increase in confidence of the address of user 160 is valid.

Different utility types may also contribute different level of assurance scores. For example, a telephone utility, which in many countries requires identity checks for services, contributes a higher level of assurance score than a pay television utility.

Personal social accounts that do not require authentication of identity prior to subscription may be weighted less than say verification of possession of the mobile phone 155, or payment of utility bills.

### Updating the Level of Assurance (250)

The level of assurance of the user 160 determined as described above may be used to update a previous level of assurance of the user 160. In this example, the identity agent 120 replaces the previous level of assurance score in the identity profile file 136 of the user 160 with the newly-determined level of assurance score.

In other examples, the identity agent 120 may store the previous level of assurance score and the newly-determined level of assurance score, and mark the newly-determined level of assurance score as “CURRENT”. As a result, a history of level of assurance score may be created over time.

The user 160 may update the level of assurance over the counter, in this case, the level of assurance score may be updated based on the following equation (2):

LoAₜ=RL*(LoAₜ₋₁+F2F) (2)

where LoAₜ, RL, LoAₜ₋₁ is per above equation (1), and F2F is the weight score attributable to a face to face check of proof of identity documents at either a trusted organisation, post office or government agency.

In other examples, the level of assurance may be reviewed regularly or on-demand even if no payment occurs. The user 160 may be prompted by the identity agent 120 to conduct a transaction with the identity agent 120, which is specifically for the purpose of maintaining the level of assurance of the user 160.

For example, the identity agent 120 may prompt the user 160 to provide the identity information of the user 160. If the identity information provided by the user 160 matches the identity information stored in the identity profile file 136 associated with the user 160, the level of assurance of the user 160 may be maintained. Otherwise, the level of assurance of the user 160 may be decreased or the identity profile file 136 associated with the user 160 may be suspended. In this case, a further transaction may be initiated to confirm the identity of the user 160 in order to maintain the level of assurance of the user 160 or keep the identity profile file 136 active.

Maintaining the level of assurance may also be initiated by an independent service provider that is networked to one or more payment recipient 110, the independent service provider may request the user 160 to conduct the transactions for the purpose of maintaining the level of assurance.

### Storing the Level of Assurance (260)

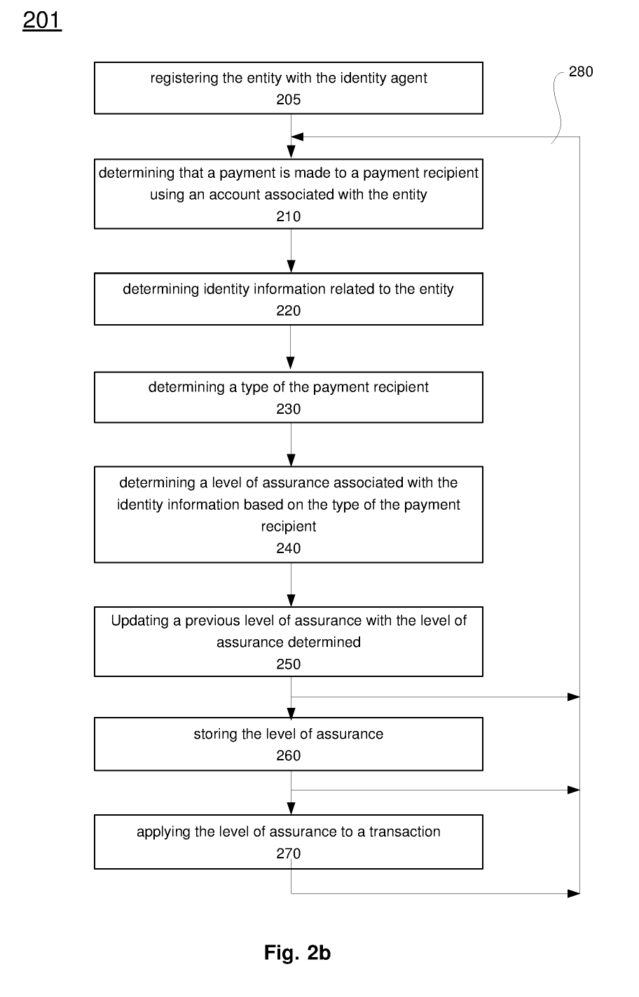

The level of assurance determined or updated as described above may be stored 260 in a storage medium other than the identity profile database 135 for future use. FIG. 3 illustrates an example method 260 for storing the level of assurance.

The identity agent 120 may determine 310 a token based on the identity information and the level of assurance.

The data contained in the token may include the user's 160 name, a unique identifier associated with the identity profile file 136, the level of assurance score, a date of assurance, an address of the user 160, the date of birth of the user 160, citizenship of the user 160, and other details the user 160 may wish to contain in the token, including loyalty scheme memberships, driver license data, a social security number or other information.

The identity agent 120 may store 320 the token on a storage medium 140. The storage medium 140 can be carried or accessed by the user 160. The storage medium 140 may be the physical card that is linked to the account 150, which may include a debit card, a credit card, a charge card, a loyalty card, a public transport access card.

The storage medium 140 may also be a separate physical medium from the physical card that is linked to the account 150, which may include a cloud storage network, a mobile computing device the user 160 carries, a Subscriber Identity Module (SIM) of the mobile phone 155 that the user 160 nominates, or an identity service provider database. The token may also be stored in a smart card that is incorporated into other medium for example passports, student IDs, library IDs.

The token may be used online or in person. For in-person transactions, the token may be provided to the payment recipient 110 via communication means including NFC, Bluetooth, Wi-Fi, LAN, or peer to peer communication means.

The token may be communicated, independent of the payment transaction, to the payment recipient 110 seeking to confirm identity of the user 160. The token may be interfaced to open identity, exchange and authorisation protocols such as OAUTH, OpenID, SAML or similar or successor protocols to allow for confirmation of the identity of the user 160 to the payment recipient 110.

The user 160 may repeat use of the storage medium 140 in providing the identity information and the level of assurance score. If the identity information and the level of assurance score provided by use of the storage medium 140 matches those stored in the identity profile database 135, the level of assurance score may be increased. Otherwise, the user 160 may be prompted to update the token by for example authenticating a payment transaction with the identity agent 120.

Accessing the token will be available with consent of the user 160 associated with the identity profile file 136 using security measures, including biometric checks, knowledge based authentication and passcodes. The token may be presented but not unlocked for access by other parties, such as a credit agency or payment recipient 110, until a time as determined by the user 160 associated with the identity profile file 136.

The soft token may be linked to Single sign-on (SSO) technologies, whereby presentation and unlocking of the soft token identifies the user 160 and permits access to a network or services.

The token presented to the payment recipient 110 or other parties, for example a credit agency, upon being unlocked may vary according to what the user 160 wishes to disclose. The user's 160 name and the level of assurance score may be disclosed to the payment recipient 110. The user 160 may disclose the date when the level of assurance score was last updated.

The token may be generated or updated at any time, ensuring that the level of assurance score associated with the identity profile file 136 is current and up to date. The payment recipient 110 may accept only recently created or updated tokens in order to ensure that integrity of identity of the user 160 is maintained.

### Applying the Level of Assurance in a Transaction (270)

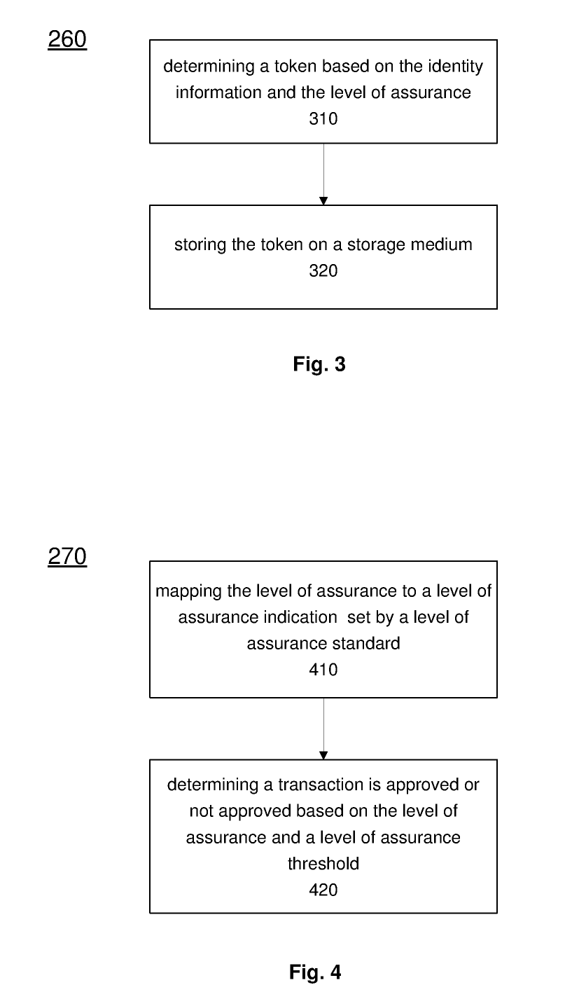

The level of assurance may be applied 270, 1270, 800 and 1800 in a transaction. FIGS. 4, 9 and 10 illustrate example methods 270, 1270, 800 and 1800 for applying the level of assurance in a transaction.

Referring to FIG. 4, the level of assurance score may be mapped 410 to a level of assurance indication set by a level of assurance standard. These indications may be represented as Level of Assurance (LoA) 1 to 4, or LoA1, LoA2, LoA3, LoA4, as often used by various governments. For example, a level of assurance score of “180” may be mapped to LoA3, and may decrease in time to a score of “150”, which may be mapped to LoA2. These indications may serve as level of assurance thresholds for transactions to be conducted with the payment recipient 110.

The payment recipient 110 may be in communication with the identity agent 120, such that updates to the level of assurance, or suspension of the identity profile file 136, may be automatically communicated between the payment recipient 110 and the identity agent 120 if necessary. In other example, the payment recipient 110 may receive a notification indicating the level of assurance score rises above or falls below a level of assurance threshold.

The payment recipient 110 may set variable level of assurance thresholds for different services. For example, a low value transaction for unregulated services such as an online purchase of clothes may have a lower threshold than a purchase of a regulated financial services product, being say for example a life insurance product. And a lower threshold may be needed for loan or mortgage services relative to the issue of a bank account. That is, the level of assurance of the user 160 conducting a transaction with the payment recipient 110 should meet the level of assurance threshold for the transaction, as determined by the party relying upon the level of assurance.

For example, a level of assurance threshold for a transaction with the payment recipient 110 may be set to LoA2, and the payment recipient 110 may send the level of assurance threshold for the transaction to the identity agent 120. When the user 160 conducts the transaction with the payment recipient 110, the identity agent 120 may retrieve the level of assurance score 139 of the user 160 from the identity profile file 136 of the user 160. In other examples, the identity agent 120 may obtain the level of assurance score of the user 160 from the token that is stored in the storage medium 140.

The identity agent 120 determines 420 the transaction is conducted based on the level of assurance threshold and the level of assurance indication mapped from the level of assurance score of the user 160. Specifically, if the level of assurance score of the user 160 is mapped by the identity agent 120 to LoA2, and the identity agent 120 may allow the transaction to be conducted by sending a notification to the user 160 or the payment recipient 110 indicating that the level of assurance indication of the user 160 meets the level of assurance threshold for the transaction. On the other hand, if the level of assurance score of the user 160 is mapped to LoA1, which is lower that the level of assurance threshold for the transaction, the identity agent 120 may not allow the transaction to be conducted by sending an alert to the user 160 or the payment recipient 110 indicating that the level of assurance indication of the user 160 does not meet the level of assurance threshold for the transaction. Therefore, the online transaction in which the user 160 is involved can be better secured.

It is to be appreciated that the application of the level of assurance to a transaction may be performed in a number ways and by different parties and in an automated way.

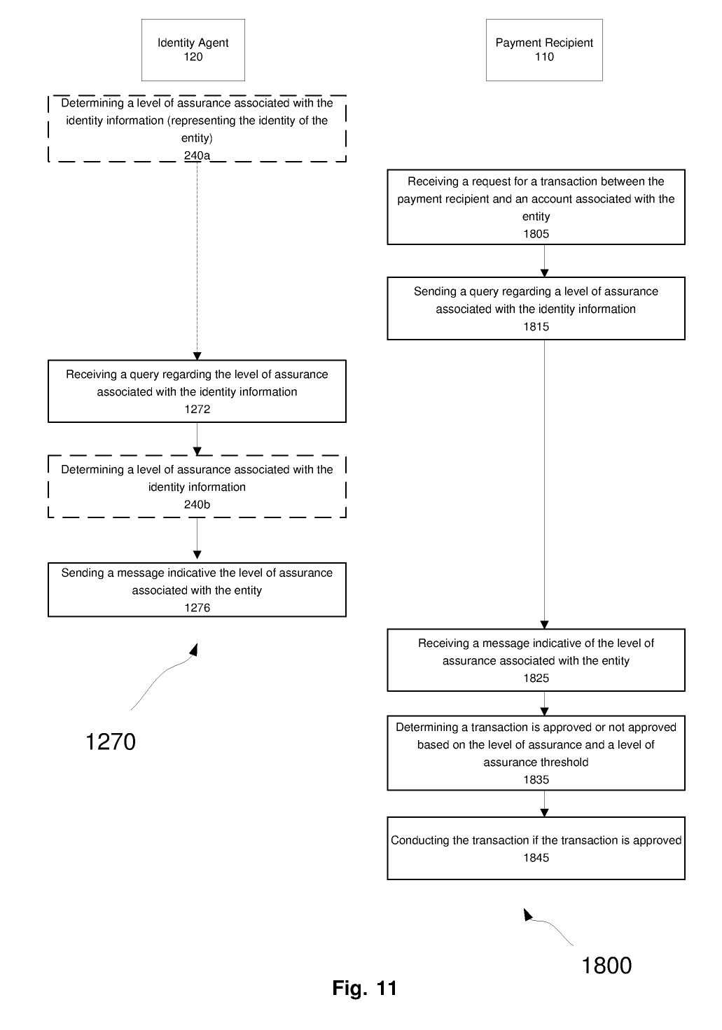

In one example as shown in FIG. 9, a payment recipient 110 receives 810 a request to perform a transaction between the payment recipient 110 and an account 150 associated with a user 160. Such a request is typically made by a user 160 represented by identity information. To have confidence that the identity information provided is accurate and genuine to the user 160 making the request, the payment recipient 110 sends a query 820 regarding the identity information to the identity agent 120. On receiving 271 the query, the identity agent 120 retrieves a previously determined 240a level of assurance associated with the identity information from the identity profile database 135 or storage medium 140. Alternatively, on receiving the query the identity agent 120 may determine 240b the level of assurance according to the method described above to obtain an up-to-date level of assurance. The identity agent 120 then determines 273 if a transaction is approved or not approved based on the determined level of assurance and a level of assurance threshold or other relevant criteria that the identity agent 120 is aware of that relates to the payment recipient 110. The result of determining whether the transaction is approved or not approved is then sent 275 in a message from the identity agent 120 to the payment recipient 110. On receiving 830 the message, the payment recipient 110 conducts 840 the transaction with the account 150 only if the message indicates the transaction is approved.

Alternatively the payment recipient 110 may decide 1800 for itself whether to allow the transaction. In one example, as illustrated in FIG. 10, the payment recipient 110 receives a request 1805 for a transaction between the payment recipient 110 and an account 150 associated with the user 160. The payment recipient 110 then sends 1815 a query regarding the level of assurance associated with the identity information to the identity agent 120. The identity agent 120 receives 1272 the query, and in response, sends 1276 a message indicative of the determined 240a, 240b level of assurance associated with the entity to the payment recipient 110. The payment recipient 110 receives 1825 the message and then determines 1835 if the transaction is approved or not approved based on the level of assurance and a level of assurance threshold and any other relevant criteria. The payment recipient 110 may then conduct 1845 the transaction only if the transaction is approved. An advantage of the payment recipient 110 deciding for itself in this example is that it does not need to share the level of assurance threshold with another party, such as the identification agent 120. This may be advantageous if the payment recipient 110 wants to keep the level of assurance threshold confidential. This may also be advantageous if the payment recipient 110 has more than one level of assurance threshold and wants to maintain management of these thresholds. For example, the payment recipient 110 may have different level of assurance thresholds associated with different types of transactions.

As shown in FIG. 2b, upon determination of the level of assurance at 240, or update of the previous level of assurance at 250, or storage of the level of the assurance at 260, or application of the level of assurance at 270, the method 201 also includes a loop 280 back to the earlier steps to iterate at least part of the method 201 for subsequent payment transactions.

The above described methods may be used for purposes including financial services, online voting, health care services, government services, or engaging with a service provider who need to establish identity to meet regulatory requirements. The identity of the user 160 may also be combined with other identity validation services such as those provided by databrokers such as VEDA, EXPERIAN, GBGroup and the like.

With the processes described above, the identity information of the user 160 may be assured, which improves security of online transactions, and also improves transaction conversion rate and reduce costs of seeking identity validation for security purposes.

### Identity Agent (120)

FIG. 9 illustrates an example identity agent 120 according to the present disclosure.

The identity agent 120 shown in FIG. 9 includes a processor 910, a memory 920 and a network interface device 940 that communicate with each other via a bus 930. The memory 920 stores instructions and data for the processes described with reference to FIGS. 2a to 8, and the processor 910 performs the instructions from the memory 920 to implement the processes. It should be noted that although the identity agent 120 is shown as an independent network element in FIG. 9, the identity agent 120 may also be part of another network element. Further, functions performed by the identity agent 120 may be distributed between multiple network elements in FIG. 1.

The processor 910 may perform the instructions from the memory 920:
to determine that a payment is made to a payment recipient using an account associated with the entity;
to determine the identity information of the entity;
to determine a type of the payment recipient; and
to determine a level of assurance associated with the identity information based on the type of the payment recipient.

### Account of the User (160)

In the present disclosure, the account 150 may be a bank account, a debit card account, a credit card account, a charge card account, a loyalty card account, a public transport access card account, an electronic money or wallet account such as PAYPAL or combination of the aforementioned accounts.

A physical card may be linked to the account 150 to be carried by the user 160 to conduct a transaction. The physical card may be a debit card, a credit card, a charge card, a loyalty card, a public transport access card or combination of the aforementioned physical cards.

If the account 150 is a payment or financial account, the account 150 may be accessed by services provided by a regulated financial institution being a bank, an interbank network, a credit card issuer or a payment service provider, for example, MAESTRO, VPAY, CARTA SI, DANKORT, PLUS, CIRRUS CARD, VISA, MASTERCARD, EFTPOS, CHINA UNIONPAY, AMERICAN EXPRESS, DINERS CLUB, DISCOVER, CARTE BLEUE, JCB CARD and KOREAN BC CARD. In this case, prior to issue of the account 150, identity of the user 160 is confirmed by the financial institution through the authentication network 115 or the third-party databases 125, 127, 130 or other appropriate means. For example, a bank or a credit card issuer may need to confirm the identity of the user 160 before issuing a debit card account or a credit card account to the user 160.

The description of the authentication process of payment using the account 150, according to one example, will now be described. During the authentication process of the payment using the account 150, the user 160 may nominate a mobile telephone 155. A verification code is sent to the mobile phone 155, and the user 160 may be requested to provide the verification code sent to the nominated mobile phone 155 for authentication purpose. This process may be repeated randomly or on a regular basis. This is useful as mobile telephones in some jurisdictions are activated for a person whose identity has been confirmed. The successful verification of possession of the mobile phone serves as a confirmation of identity and may increase the level of assurance score.

Data related to the user's 160 proof of identity, including a name, an age, an address, citizenship, a social security number may be collected by use of the network access device 145 in conjunction with the authentication process of the payment by the authentication network 115. In the case of the user 160 being a company, the data may include a company registration number, names of directors and a stock exchange identifying code for the company. Further personal details such as a driver license number, a passport number, a tax file number, a government identification number, a national resident identification card (NRIC) number, or other details may also be collected.

Data related to the network 105 used by the user 160 may be collected during the authentication process, including an Internet Protocol (IP) address, data routings and domain information.

Data related to the network access device 145 used by the user 160 to make the payment may be collected during the authentication process, including a unique device identifiers, a serial number, an International Mobile Station Equipment Identity (IMEI) and Electronic Serial Number (ESN), a Customer-Premises Equipment (CPE) number, a Media Access Control (MAC) address, Subscriber Identity Module (SIM) details, a Universally Unique Identifier (UUID), a Near Field Communication (NFC) Identifier, Apple Pay identity and a Host Card Emulation (HCE) identifier.

Details to allow other user(s) to access the account 150 may also be provided by the user 160 during the authentication process in order to confirm that the user 160 has ownership of the account 150.

The user 160 may provide, during the authentication process, personal social account information associated with the user 160 such as email addresses, social media profiles including FACEBOOK, TWITTER, LINKEDIN, additional mobile or telephone details, instant message addresses, over the top communications addresses including WHATSAPP, or other means of communicating with the user 160. Further additional personal information may include social accounts such as a frequent flyer account, and/or a store, hotel, travel and/or car hire loyalty scheme. Verification of ownership of these personal social accounts may be confirmed by the user 160 providing login details of these personal social accounts.

Association of multiple accounts 150 from independent issuers with the identity profile file 136 may increase the level of assurance score as independent security and authentication systems from the independent issuers have been applied to the identity profile file 136.

The authentication process of the payment may be conducted by use of 3D-SECURE, a deposit of two or more amounts to the account 150, a random identifier with the payment transaction, ISIGNTHIS, two-factor authentication, multi-factor authentication, biometrics linked to the account 150, and other authentication methods.

Further, the processes, methods and functional units described in this disclosure may be implemented by hardware or by software. For example a plurality of machine readable instructions stored on a non-transitory storage medium and executable by a processor to implement the methods and functional units recited in the examples of the present disclosure. There may be a single processor and non-transitory storage medium or plural processors and/or storage mediums in which case the methods and functional units may be distributed between them.

The figures are only illustrations of an example, wherein the functional units or procedure shown in the figures are not necessarily essential for implementing the present disclosure. The units in the devices in the examples can be arranged as described, or can be located in one or more devices differently than shown in the examples.

Although the flow charts described show a specific order of execution, the order of execution may differ from that which is depicted. For example, the order of execution of two or more blocks may be changed relative to the order shown. Also, two or more blocks shown in succession may be executed concurrently or with partial concurrence. All such variations are within the scope of the present disclosure.

1. A computer-implemented method for assuring identity information representing identity of an entity, comprising:
determining that a payment is made to a payment recipient using an account associated with the entity;
determining identity information related to the entity;
determining a type of the payment recipient; and
determining a level of assurance associated with the identity information based on the type of the payment recipient.

2. The computer-implemented method according to claim 1, further comprising:
storing the level of assurance in a database.

3. The computer-implemented method according to claim 1, wherein determining the level of assurance further comprises determining the level of assurance based on the identity information.

4. The computer-implemented method according to claim 3, wherein determining the identity information comprises determining the identity information based on a further account associated with the entity.

5. The computer-implemented method according to claim 1, wherein the type of the payment recipient comprises a regulated payment recipient and an unregulated payment recipient.

6. The computer-implemented method according to claim 5, wherein the regulated payment recipient comprises one or more of the following:
a utility company;
a government agency;
a financial institution;
a quasi-government agency; and
an entity regulated under anti-money laundering, counter terrorism funding, bank secrecy or financial regulatory requirements.

7. The computer-implemented method according to claim 1, wherein determining the level of assurance further comprises:
comparing the identity information with a record representing the identity of the entity in a third-party database; and
determining the level of assurance based on the comparing.

8. The computer-implemented method according to claim 7, wherein the third-party database comprises a government agency database, a credit agency database and a databroker database.

9. The computer-implemented method according to claim 1 wherein the account comprises a bank account, a debit card account, a credit card account, a charge card account, a loyalty card account, a public transport access card account or combination thereof.

10. The computer-implemented method according to claim 1, further comprising:
determining a token based on the identity information and the level of assurance.

11. The computer-implemented method according to claim 10, wherein the token contains one or more of the following:
a name of the entity;
a unique identifier associated with the entity;
the level of assurance;
a date of assurance;
an address;
a date of birth;
citizenship;
loyalty scheme memberships;
tax file number;
passport number, with expiry and place of issue;
driver license data; and
a social security number.

12. The computer-implemented method according to claim 10, further comprising:
storing the token on a storage medium,
wherein the storage medium comprises a debit card, a credit card, a charge card, a loyalty card, a public transport access card, a cloud storage network, a mobile computing device, a Subscriber Identity Module (SIM) of a mobile phone, an identity service provider database and a smart card that is incorporated into another medium.

13. The computer-implemented method according to claim 1, wherein determining the level of assurance further comprises determining the level of assurance based on one or more factors including:
type of account;
verified possession of a mobile phone number by the entity;
device information of a device the payment was made with;
when a utility has been paid by the entity;
type of utilities paid by the entity;
payment history
failed payment authentications associated with the entity;
authenticated transactions made to utilities;
regulated payment recipients have been paid;
one or more social network accounts associated with the entity;
an amount of the payment;
data routing and domain information of the payment;
one or more email accounts associated with the entity; and
a face-to-face check of proof of identity documents of the entity.

14. The computer-implemented method according to claim 13, wherein determining the level of assurance comprises:
assigning weights to one or more of the one or more factors; and
determining the level of assurance based on weights.

15. The computer-implemented method according to claim 1, further comprising:
updating a previous level of assurance associated with the identity information of the entity with the level of assurance.

16. A computer-implemented method of approving a transaction between a payment recipient and an account associated with an entity, wherein the identity of the entity is represented by identity information, the method comprising:
determining a level of assurance associated with the identity information according to claim 1; and
determining a transaction is approved or not approved based on the level of assurance.

17. The computer-implemented method according to claim 16, further comprising:
receiving a query regarding the identity information in the transaction; and
sending a message indicative of a result of determining the transaction is approved or not approved.

18. A computer-implemented method of performing a transaction between a payment recipient and an account associated with an entity, wherein the identity of the entity is represented by identity information, the method comprising:
receiving a request for the transaction between the payment recipient and the account associated with the entity;
sending a query based on the identity information in the transaction;
receiving a message indicative of a result of determining the transaction is approved or not approved according to claim 16; and
conducting the transaction if the transaction is approved.

19. The computer-implemented method according to claim 1 further comprising:
receiving a query regarding the level of assurance associated with the identity information; and
sending a message indicative of the level of assurance associated with the entity.

20. A computer-implemented method of performing a transaction between a payment recipient and an account associated with an entity, wherein the identity of the entity is represented by identity information, the method comprising:
receiving a request for the transaction between the payment recipient and the account associated with the entity;
sending a query regarding the level of assurance associated with the identity information;
receiving a message indicative of the level of assurance associated with the entity according to claim 1;
determining a transaction is approved or not approved based on the level of assurance and a level of assurance threshold; and
conducting the transaction if the transaction is approved.

21. A non-transitory computer readable medium having computer readable instructions for assuring identity information representing identity of an entity, comprising:
determining that a payment is made to a payment recipient using an account associated with the entity;
determining the identity information of the entity;
determining a type of the payment recipient; and
determining a level of assurance associated with the identity information based on the type of the payment recipient.

22. A computer program comprising machine-executable instructions to cause a processing device to implement the method according to claim 1.

23. A computer system for assuring identity information representing identity of an entity, comprising:
a memory to store instructions;
a bus to communicate the instructions from the memory;
a processor to perform the instructions from the memory communicated via the bus
to determine that a payment is made to a payment recipient using an account associated with the entity;
to determine the identity information of the entity;
to determine a type of the payment recipient; and
to determine a level of assurance associated with the identity information based on the type of the payment recipient.

24. A computer system for performing a transaction between a payment recipient and an account associated with an entity, wherein the identity of the entity is represented by identity information, comprising:
a memory to store instructions;
a bus to communicate the instructions from the memory;
a processor to perform the instructions from the memory communicated via the bus to perform the method of claim 18.
